(19) United States
(12) Patent Application Publication
(10) Pub. No.: US 2025/0162911 A1
(43) Pub. Date: May 22, 2025

(54) METHODS OF DEWATERING WASTE STREAMS CONTAINING ENTRAINED PARTICLES

(71) Applicant: SOLENIS TECHNOLOGIES, L.P., Wilmington, DE (US)

(72) Inventors: Daniel Joseph Nicholson, Swarthmore, PA (US); Sachin Borkar, Wilmington, DE (US)

(73) Assignee: SOLENIS TECHNOLOGIES, L.P., Wilmington, DE (US)

(21) Appl. No.: 18/925,358

(22) Filed: Oct. 24, 2024

Related U.S. Application Data
(60) Provisional application No. 63/601,845, filed on Nov. 22, 2023.

(51) Int. Cl. C02F 1/52; C02F 103/28

(52) U.S. Cl. CPC C02F 1/5272; C02F 2103/28; C02F 2209/02; C02F 2303/24

(57) ABSTRACT

Methods are provided for dewatering a water stream containing entrained particles. The water stream may be a wastewater stream from a papermaking process. Separation of the entrained particles from the water is achieved using a clarifying composition that contains a vinylamine-containing polymer or precursor(s) thereof. The vinylamine-containing polymer acts as a flocculant to effectuate separation. Then, the mixture is separated in a clarifier unit to produce a clarified water stream and clarifier bottoms.

### TECHNICAL FIELD

The present disclosure generally relates to methods of dewatering waste streams containing entrained particles, and more particularly relates to methods of dewatering waste streams that exhibit harsh conditions such as high temperature and alkaline conditions.

### BACKGROUND

Separation of entrained particles from water streams is an important unit operation in many industrial processes to ensure product quality, protect equipment, comply with environmental regulations, and meet health and safety standards. For example, particle separation from water is widely employed in the paper and pulp industry, mining, textile, and sewage treatment industries.

Various techniques are employed to separate entrained particles from water streams such as, for example, sedimentation, filtration, centrifugation, and flocculation. Flocculation, in particular, involves adding a flocculant or clarifying composition to the water stream, which results in agglomeration of the entrained particles, or “floc” formation. The flocs can then be separated from the water by sedimentation.

Flocculation can be a time-consuming process, often requiring holding times of up to 12 hours to yield targeted decrease in entrained particles to target levels. Furthermore, conditions in the water stream can present challenges as temperature, pressure, pH, and other factors can affect efficacy of the flocculant. Therefore, it can be challenging to select appropriate chemistries that can both withstand potentially harsh conditions associated with various water streams to be treated and that can effectively flocculate particles from the water streams within a reasonable timeframe. Further, there is a constant drive to minimize flocculant load needed to achieve desired performance.

Various water streams in papermaking are subject to flocculation. Examples of such water streams are green liquor, green liquor dregs, white liquor, white liquor mud, bleach plant effluent, and coating and sizing wastewater. Green liquor and green liquor dregs, in particular, often have a high temperature and are alkaline in pH during flocculation. To form green liquor, smelt from a Kraft paper process is dissolved in water, with the resulting green liquor transferred to a clarifier unit for flocculation. After an appropriate holding time, green liquor dregs are taken as clarifier unit bottoms and are subject to further remediation while a clarified water stream is further processed with quicklime in a causticizing tank to convert the solution back to white liquor for return to a digester system of the Kraft process. Green liquor dregs are notoriously difficult to process due to high alkalinity, high water content (the green liquor dregs still contain high amounts of water, such as at least 10 wt %), and presence of calcium-based compounds that often lead to scale formation and fouling of equipment surfaces.

Accordingly, it is desirable to provide methods of dewatering water streams that contain entrained particles, particularly water streams that exhibit harsh conditions such as high temperature and alkaline conditions that may present flocculation challenges. In addition, it is desirable to provide methods of dewatering water streams with flocculant chemistries that may exhibit enhanced performance under the aforementioned harsh conditions. Further still, it is desirable to maximize particle separation with minimized holding times to accomplish target particle separation. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Methods for dewatering a water stream containing entrained particles are provided herein. In an embodiment, a method for dewatering a water stream containing entrained particles includes providing a water stream containing water and entrained particles and having a pH of at least about 8 and a temperature of at least about 50° C. The method involves combining the water stream and a clarifying composition that includes a vinylamine-containing polymer or precursor(s) thereof. The method further involves separating the entrained particles from the water after combining the water stream and the clarifying composition.

Exemplary papermaking processes are also provided herein. In an embodiment, a papermaking process involves cooking a fibrous material in white liquor to produce kraft pulp. Then, after cooking, the process involves separating the kraft pulp from black liquor and processing the black liquor to produce a combusted smelt product. The combusted smelt product is then dissolved in water to produce green liquor comprising water and entrained particles and having a pH of at least about 8 and a temperature of at least about 50° C. The process involves combining the green liquor and a clarifying composition comprising vinylamine-containing polymer or precursor(s) thereof, and then separating the entrained particles from the water.

### BRIEF DESCRIPTION OF THE DRAWINGS

The present disclosure will hereinafter be described in conjunction with the following drawing figures, wherein like numerals denote like elements, and wherein:

FIG. 1 shows a method of dewatering a water stream containing entrained particles.

FIG. 2 shows an exemplary papermaking process.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Methods of dewatering water streams that contain entrained particles are provided herein. The methods described herein are particularly directed to dewatering water streams that exhibit harsh conditions such as high temperature of at least about 50° C. and alkaline conditions, with a pH of at least about 8, that may ordinarily present flocculation challenges. However, in accordance with the subject methods, the water stream is combined with a clarifying composition that includes vinylamine-containing polymer or precursor(s) thereof. Vinylamine-containing polymer can include polyvinylamine (PVAm) homopolymer or copolymers including vinylamine groups and at least one additional group derived from a comonomer. Precursor(s) of vinylamine-containing polymer include vinylcarboxamide-containing polymer. The vinylcarboxamide-containing polymer may be a poly(N-vinylcarboxamide) homopolymer, such as polyvinylformamide (PVFA) homopolymer. Alternatively, the vinylcarboxamide-containing polymer may be a copolymer including two or more different carboxamide groups, or a copolymer including carboxamide groups and at least one additional group derived from a comonomer having a formula different from the carboxamide groups. Vinylcarboxamide-containing polymer may exhibit enhanced performance under the aforementioned harsh conditions because hydrolysis of carboxamide groups (such as formamide groups) into highly cationic primary amine is promoted under such conditions. As a result, in-situ hydrolysis of carboxamide groups that may be present in the vinylcarboxamide-containing polymer may be exploited to maximize cationic charge of the vinylamine-containing polymer and/or vinylcarboxamide-containing polymer, leading to maximized flocculation performance while potentially avoiding processing and stabilization challenges that may be associated with pre-hydrolyzing vinylcarboxamide-containing polymer to produce vinylamine-containing polymer prior to combining with the water stream.

Unless specifically stated or obvious from context, as used herein, the term “about” is understood as within a range of normal tolerance in the art measured using standard measurement devices, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, the term “dry” or the phrase “in dry form” indicates that a clarifying composition contains less than about 10 weight percent (wt %) water, alternatively less than about 5 wt % water, alternatively less than about 1 wt % water, alternatively from about 0 wt % to about 1 wt % water, based on the total weight of the clarifying composition.

As used herein, the term “water stream” refers to a stream containing water in a continuous liquid phase and entrained particles that are entrained in the water. “Entrained particles” refers to materials that are solid at ambient temperature and pressure and that are present in the water stream before the water stream is combined with the clarifying composition. In embodiments, the entrained particles are combustion products such as ash, which may be derived from cellulosic fiber or other organic matter.

As used herein, the term “homopolymer” refers to a polymer only containing repeating units of a single type of monomer. The term “copolymer” refers to a polymer containing repeating units of multiple different types of monomer. This means that the polymer is made up of two or more monomeric species.

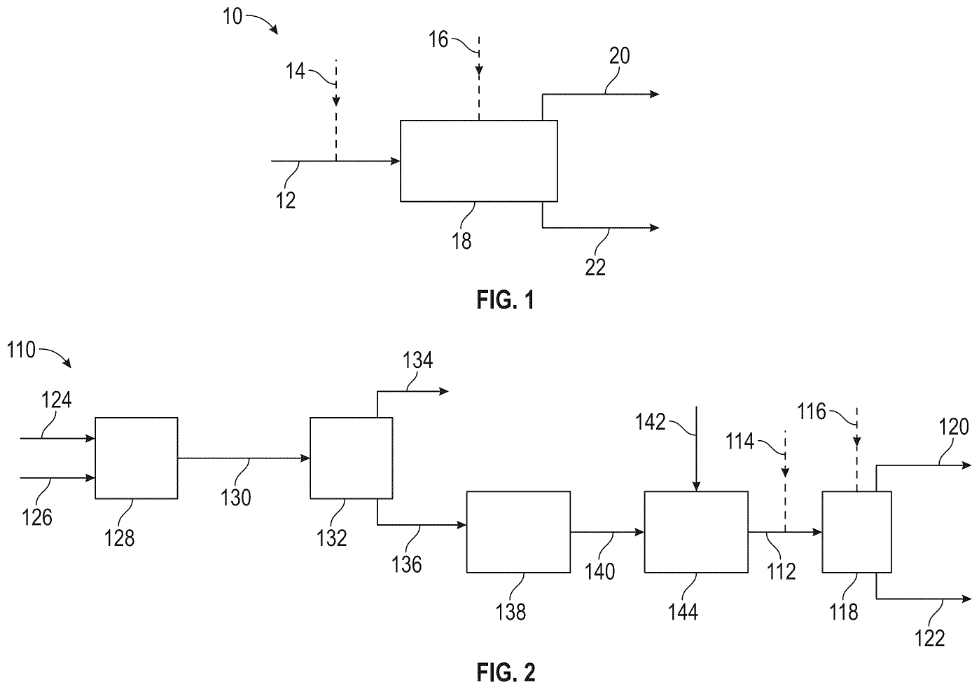

Methods 10 of dewatering a water stream 12 containing entrained particles are provided herein and are illustrated in FIG. 1. Exemplary papermaking processes 110 that incorporate the dewatering methods 10 are also provided herein and illustrated in FIG. 2. Referring to FIG. 1, in accordance with an exemplary method of dewatering a water stream 12 containing entrained particles, a water stream 12 is provided that contains water and entrained particles. The water stream 12 has a pH of at least about 8 and a temperature of at least about 50° C. In an embodiment, the water stream 12 has a temperature of from about 75° C. to about 100° C. and a pH of from about 10 to about 13. The water stream 12 may have an initial suspended solids content of from about 100 to about 5000 ppm.

In embodiments, the water stream 12 is a wastewater stream from a papermaking process. Referring momentarily to FIG. 2, the water stream may be a wastewater stream 112 from a papermaking process 110. For example, the wastewater stream 112 may be a wastewater stream 112 provided into a clarifier unit 118, such as green liquor. Alternatively, the water stream may be a dregs stream 122. In other embodiments, and although not shown, the water stream may be a tailings stream from a mining operation.

In accordance with an exemplary method, and now referring to FIG. 1, the water stream 12 and a clarifying composition 14,16 are combined. In an embodiment, the clarifying composition 14 is combined with the water stream 12 upstream of the clarifier unit 18. In another embodiment, the clarifying composition 16 is combined with the water stream 12 within the clarifier unit 18. The clarifying composition 14,16 includes vinylamine-containing polymer or precursor(s) thereof. In an embodiment, the vinylamine-containing polymer may be a homopolymer that contains only vinylamine groups i.e. polyvinylamine (PVAm). In other embodiments, the vinylamine-containing polymer may be a copolymer which contains vinylamine groups and at least one additional group derived from a comonomer. For example, the vinylamine-containing polymer may be a poly(vinylformamide-co-vinylamine) or a poly(vinylamine-co-vinylacetamide). In embodiments, the vinylamine-containing polymer has a weight average molecular weight of greater than 50,000 Daltons.

In an embodiment, the clarifying composition 14,16 includes vinylcarboxamide-containing polymer as the precursor to the vinylamine-containing polymer. As used herein, a vinylcarboxamide-containing polymer is defined as a polymer formed from the polymerization of one or more N-vinylcarboxamide monomer(s) of Formula I

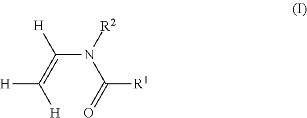

in which R¹ and R², independently of one another, are H or C₁ to C₆ alkyl groups. Examples of N-vinylcarboxamide monomers include N-vinylformamide, N-vinyl-N-methylacetamide, N-vinyl-N-methylformamide, N-vinylacetamide, N-vinyl-N-ethylacetamide, N-vinylpropionamide, N-vinyl-N-methyl-propionamide, N-vinylbutyramide, or combinations thereof. Optionally, the polymerization may also include one or more additional vinyl monomer(s) which are different from Formula I. “Vinyl monomer(s)” refers to monomer(s) which have (H₂C═C—) group in their structure. Vinyl monomers could alternatively be defined as ethylenically unsaturated monomers. Examples of suitable vinyl monomers having a formula different from formula I include, but are not limited to, N-vinylpyrrolidone, acrylamide, acrylic acid, vinyl acetate, methyl acrylate, or combinations thereof.

The vinylcarboxamide-containing polymer may be a homopolymer or a copolymer. For example, if the N-vinylcarboxamide monomers used in the polymerization are N-vinylformamide monomers, then the vinylcarboxamide-containing polymer may be polyvinylformamide (PVFA) homopolymer or copolymers including formamide groups and at least one additional group derived from a comonomer.

In this embodiment, the vinylcarboxamide-containing polymer is combined with the water stream without expressly hydrolyzing the vinylcarboxamide-containing polymer, with carboxamide groups hydrolyzed in-situ in the water stream to form a vinylamine-containing polymer having primary amine groups. In embodiments, the vinylcarboxamide-containing polymer may have carboxamide groups present in an amount of from about 3 to about 99 mol %, based on the total number of pendant groups of the vinylcarboxamide-containing polymer.

In some embodiments, the clarifying composition 14,16 may include the vinylamine-containing polymer or precursor(s) thereof in an amount of at least about 40 wt %, based on a total weight of the clarifying composition. In some embodiments, the clarifying composition may be combined with the water stream such that the amount of the clarifying composition is from about 2 to about 10 ppm by mass, based on a total weight of the water stream.

The clarifying composition 14,16 may be provided in a variety of different forms for combination with the water stream. For example, in an embodiment, the clarifying composition 14,16 is in dry form and includes vinylcarboxamide-containing polymer as the precursor to the vinylamine-containing polymer. In this embodiment, the vinylcarboxamide-containing polymer may be in particulate form, although other dry forms of the vinylcarboxamide-containing polymer may also be provided. In other embodiments, the clarifying composition 14,16 is in aqueous solution, emulsion, or dispersion form. In these embodiments, vinylcarboxamide-containing polymer in dry form may be dissolved in water immediately prior to combining with the water stream 12.

Providing the clarifying composition 14,16 in particulate form is beneficial because it allows for transportation and storage of larger quantities of active polymer in the clarifying composition, and a longer shelf life of the clarifying composition, than when the clarifying composition is provided in another form. It may also allow the clarifying composition to contain polymer having a higher molecular weight than possible with other forms of the clarifying composition, leading to improved performance of the polymer in the process of dewatering a water stream containing entrained particles.

If the vinylcarboxamide-containing polymer is in particulate form, the vinylcarboxamide-containing polymer may be provided in granular bead form. In embodiments, the granular beads have a D50 particle size of from about 50 microns to about 800 microns. Poly(N-vinylcarboxamide) or its copolymers can be produced in a granular bead form through an inverse suspension polymerization process. Such a polymerization process includes a thermal-type polymerization, using a thermal initiator such as V-50 initiator (2,2′-Azobis(2-methylpropionamidine)dihydrochloride) available from FUJIFILM Wako Chemicals USA, Corp. In addition, conventional free radical initiating systems can be used in the polymerization process (e.g. Redox system). Aqueous monomer is dispersed in a low boiling hydrocarbon liquid with an added polymeric stabilizer to aid monomer droplet formation. The dispersion is deoxygenated. The contents are then heated to the appropriate temperature. External heating is removed, redox initiators are added, and adiabatic exothermic polymerization takes place. The product produced by the polymerization is formed into a granular bead or a micro bead, and the water from the produced polymer is removed, for example through azeotropic distillation. Once the water has been removed, the resultant product precipitates and can be physically separated from any dispersion medium and dried through any conventional drying techniques.

In the embodiment in which the clarifying composition includes vinylcarboxamide-containing polymer as a precursor to vinylamine-containing polymer, the vinylcarboxamide-containing polymer is not expressly hydrolyzed prior to combining the clarifying composition with the water stream. Rather, the clarifying composition including vinylcarboxamide-containing polymer is combined with the water stream, and the conditions of the water stream effectuate in situ hydrolysis of carboxamide groups in the vinylcarboxamide-containing polymer to form a vinylamine-containing polymer. Specifically, the alkaline pH (at least about 8) and high temperature (at least about 50° C.) of the water stream promote hydrolysis of the carboxamide groups.

In situ hydrolysis of carboxamide groups present in the vinylcarboxamide-containing polymer to form primary amine groups and create a vinylamine-containing polymer is beneficial because it maximizes the cationic charge of the vinylamine-containing polymer, leading to maximized flocculation performance. At the same time, in situ hydrolysis can potentially prevent processing and stabilization challenges that may be associated with expressly pre-hydrolyzing vinylcarboxamide-containing polymer to produce vinylamine-containing polymer prior to combining the clarifying composition with the water stream.

In embodiments, upon combination of the clarifying composition including vinylcarboxamide-containing polymer with the water stream, the degree of hydrolysis of carboxamide groups to form primary amine groups in the vinylcarboxamide-containing polymer is from about 2 mol % to about 98 mol %, alternatively from about 40 mol % to about 80 mol %, based on the total moles of carboxamide groups present in the vinylcarboxamide-containing polymer prior to combining with the water stream, when the water stream has a pH of at least about 8 and a temperature of at least about 50° C. The degree of hydrolysis is from about 60 mol % to about 70 mol %, alternatively from about 40 mol % to about 95 mol %, based on the total moles of carboxamide groups present in the vinylcarboxamide-containing polymer prior to combining with the water stream, when the water stream has a pH of about 10 to about 13 and a temperature of about 75° C. to about 100° C.

The hydrolysis of the carboxamide groups to form primary amine groups is considered to be “complete” when the degree of hydrolysis is within the ranges described above. The hydrolysis may be “complete” as defined herein after about 10 minutes to about 600 minutes, alternatively after about 60 minutes to about 180 minutes, when the water stream has a pH of at least about 8 and a temperature of at least about 50° C. The hydrolysis may be “complete” within from about 10 minutes to about 60 minutes, alternatively from about 15 minutes to about 30 minutes, when the water stream has a pH of about 10 to about 13 and a temperature of about 75° C. to about 100° C. After the hydrolysis is complete, the content of cationic groups in the resulting vinylamine-containing polymer may be from about 2 mol % to about 98 mol %, alternatively from about 40 mol % to about 80 mol %, based on the total moles of the vinylamine-containing polymer, when the water stream has a pH of at least about 8 and a temperature of at least about 50° C. The content of cationic groups in the resulting vinylamine-containing polymer may be from about 60 mol % to about 70 mol %, alternatively from about 40 mol % to about 95 mol %, based on the total moles of the vinylamine-containing polymer, when the water stream has a pH of about 10 to about 13 and a temperature of about 75° C. to about 100° C.

After the in situ hydrolysis has occurred, the resulting vinylamine-containing polymer contains primary amine groups, which are highly cationic. Because of the cationic nature of the primary amine functional groups in the vinylamine-containing polymer, the polymer readily couples with the entrained particles in an aqueous solution such as the water stream. In particular, the primary amine groups in the vinylamine-containing polymer ionically interact with the entrained particles, which contain anionic groups. This ionic interaction causes agglomeration of the particles. The agglomerated particles form concentrated regions of particles in the water stream which can then be separated from the water as described below.

In accordance with the exemplary method, and with continued reference to FIG. 1, after the water stream 12 and the clarifying composition 14,16 are combined, the entrained particles are separated from the water. The entrained particles may be separated from the water, for example, in a clarifier unit 18. Upon combination of the clarifying composition 14,16 and the water stream 12, the clarifying composition 14,16 causes flocculation of the entrained particles in the water stream 12. The flocculated entrained particles are then separated by, for example, a sedimentation or filtration process within the clarifier unit 18.

The streams resulting from the separation include a clarified water stream 20 and clarifier bottoms 22. The clarified water stream 20 contains a lower concentration of entrained particles than the water stream 12. In some embodiments, the clarified water stream 20 may contain less than 100 ppm of entrained particles, alternatively less than 25 ppm of entrained particles. The clarifier bottoms 22 contain a vinylamine-containing polymer and a higher concentration of entrained particles than the water stream 12.

In an embodiment, and with continued reference to FIG. 1, the clarifier bottoms 22 may have a solids concentration of at least about 10 wt. %, alternatively at least about 50 wt. %, alternatively from about 10 wt. % to about 90 wt. %, alternatively from about 30% to about 70%, based on a total weight of the clarifier bottoms 22. In some embodiments, the clarifier bottoms 22 may be subject to additional processing to further concentrate the solid particles for disposal or remediation. In other embodiments, the clarified water stream 20 may be subject to additional processing to remove additional remaining entrained particles, which may allow the clarified water stream 20 to be recycled or used in another unit operation.

In a specific embodiment as contemplated herein, the water stream is a wastewater stream from a papermaking process, particularly a water stream provided into a clarifier unit. For example, the wastewater stream may be green liquor or green liquor dregs. The clarifying composition is combined with the water stream, preferably upstream of the clarifier unit or within the clarifier unit. The step of separating the entrained particles from the water includes producing clarifier bottoms and a clarified water stream.

In an embodiment, the clarified water stream has less than 100 ppm, or alternatively less than 25 ppm, of entrained particles. In an embodiment, the clarified water stream may be further processed to create a stream such as white liquor, which can be returned into the papermaking process.

The clarifier bottoms contain polyvinylamine-containing polymer and entrained particles. In an embodiment, the clarifier bottoms have a solids concentration of at least 10 wt. %, alternatively at least 50 wt. %, alternatively from about 10 wt. % to about 90 wt. %, alternatively from about 30 wt. % to about 70 wt. %, based on a total weight of the clarifier bottoms. In an embodiment, the clarifier bottoms are collected after a holding time of less than 4 hours in a clarifier unit. The method as contemplated herein allows production of a clarifier bottoms having a solids concentration of at least 10 wt. %, alternatively at least 50 wt. %, alternatively from about 10 wt % to about 90 wt %, alternatively from about 30 wt % to about 70 wt %, based on a total weight of the clarifier bottoms, with a holding time of less than 4 hours. This high of a solids concentration in the clarifier bottoms with this low of a holding time has not previously been achievable.

In an embodiment, after the entrained particles are separated from the water to produce clarifier bottoms and a water stream, the clarifier bottoms may be further concentrated to produce a washed clarifier bottoms composition having a solids content of at least 50 wt. % solids, alternatively from about 10 wt % to about 90 wt %, alternatively from about 30 wt % to about 70 wt %, based on a total weight of the washed clarifier bottoms composition.

In one particularly specific embodiment as contemplated herein, and with reference to FIG. 2, the water stream is green liquor 112 from a papermaking process 110. In accordance with an exemplary papermaking process 110, a fibrous material 124 is combined with white liquor 126 in a digestor 128. The white liquor may contain sodium hydroxide, sodium sulfide, or combinations thereof. The fibrous material 124 is cooked in the white liquor 126 to produce kraft pulp 130. After cooking, the kraft pulp 130 is separated from black liquor 136 in a separator 132. The black liquor 136 is then processed to produce a combusted smelt product 140. For example, the black liquor 136 may be combusted in a recovery boiler 138. The combusted smelt product 140 is dissolved in water 142 to produce green liquor 112. The green liquor 112 contains water and entrained particles. The green liquor 112 has a pH of at least about 8 and a temperature of at least about 50° C. In this embodiment, the entrained particles in the green liquor 112 include calcium or iron-containing compounds, or combinations thereof. The clarifying composition 114,116 is combined with the green liquor 112. In one variation of this embodiment, the clarifying composition 114 is combined with the green liquor 112 upstream of a clarifier unit 118. In another variation of this embodiment, the clarifying composition 116 is combined with the green liquor 112 within the clarifier unit 118. In this embodiment, a dregs stream 122 is separated from a liquid recovery stream 120. The dregs stream 122 includes a vinylamine-containing polymer and the entrained particles.

The liquid recovery stream 120 may be further processed. In an embodiment, the liquid recovery stream 120 may be processed to produce white liquor. The white liquor can then be returned to a papermaking process 110 and reused.

The dregs stream 122 may be further processed and remediated. For example, in an embodiment, the dregs stream 122 may be further concentrated to produce a washed dregs stream having a solids content of at least 10 wt. % solids, alternatively least 50 wt. % solids, alternatively from about 10 wt. % to about 90 wt. % solids, alternatively from about 30 wt % to about 70 wt %, based on a total weight of the washed dregs stream. In another embodiment, a clarifying composition may be combined with the dregs stream 122, preferably upstream of or within a downstream clarifier unit. Further separation of entrained particles from the dregs stream occurs in the downstream clarifier unit. In this embodiment, the dregs stream is separated to produce a further clarified water stream and clarifier bottoms containing a vinylamine-containing polymer and entrained particles.

It is to be appreciated that any or all of the components above (e.g. monomers, modifiers, etc.) may be prepared or otherwise obtained (e.g. from commercial sources). Moreover, such components and/or the reagents used to prepare the same may originate from traditional (e.g. fossil-based) sources, or instead may be bio-based, i.e., prepared using biological methods and/or from products of such methods. In some embodiments, the method utilizes all bio-based components in the preparation of the vinylamine containing polymers. In other embodiments, at least a portion of a component is bio-based.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A method of dewatering a water stream containing entrained particles, wherein the method comprises:
providing the water stream, wherein the water stream comprises water and the entrained particles, and wherein the water stream has a pH of at least about 8 and a temperature of at least about 50° C.;
combining the water stream and a clarifying composition comprising vinylamine-containing polymer or precursor(s) thereof; and
separating the entrained particles from the water after combining the water stream and the clarifying composition.

2. The method of claim 1, wherein combining the water stream and the clarifying composition comprises combining the water stream and vinylcarboxamide-containing polymer as the precursor to the vinylamine-containing polymer, wherein the vinylcarboxamide-containing polymer was formed from one or more N-vinylcarboxamide monomer(s) of Formula I 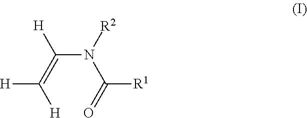
wherein R¹ and R², independently of one another, are H or C₁ to C₆ alkyl groups, wherein carboxamide groups of the vinylcarboxamide-containing polymer hydrolyze in-situ to form vinylamine-containing polymer having primary amine groups.

3. The method of claim 2, wherein combining the water stream and the vinylcarboxamide-containing polymer comprises combining the water stream and the vinylcarboxamide-containing polymer having vinylcarboxamide groups present in an amount of from about 3 to about 99 mol %, based on the total number of pendant groups of the vinylcarboxamide-containing polymer.

4. The method of claim 1, wherein combining the water stream and the clarifying composition comprises combining the water stream and clarifying composition in dry or aqueous solution or emulsion or dispersion form.

5. The method of claim 4, wherein combining the water stream and the clarifying composition in dry form comprises combining the water stream and vinylformamide-containing polymer in particulate form.

6. The method of claim 1, wherein providing the water stream comprises providing the water stream at a temperature of from about 75° C. to about 100° C. and a pH of from about 10 to about 13.

7. The method of claim 1, wherein providing the water stream comprises providing a wastewater stream from a papermaking process.

8. The method of claim 7, wherein the water stream has initial suspended solids of from 100 to about 5000 ppm.

9. The method of claim 8, wherein separating the entrained particles from the water comprises producing a clarified water stream having less than 100 ppm of entrained particles.

10. The method of claim 9, wherein separating the entrained particles produces the clarified water stream having less than 25 ppm of entrained particles.

11. The method of claim 9, wherein separating the entrained particles from the water comprises producing clarifier bottoms having a solids concentration of at least 10 wt. %, based on a total weight of the clarifier bottoms.

12. The method of claim 11, further comprising concentrating the clarifier bottoms to produce a washed clarifier bottoms composition having a solids content of at least 50 wt. % solids, based on a total weight of the washed clarifier bottoms composition.

13. The method of claim 11, wherein producing the clarifier bottoms comprises collecting the clarifier bottoms after a holding time of less than 4 hours in a clarifier unit.

14. The method of claim 7, wherein providing the water stream comprises providing green liquor, wherein the entrained particles include calcium and/or iron-containing compounds.

15. The method of claim 14, wherein combining the green liquor and the clarifying composition comprises combining the green liquor and the clarifying composition upstream of or within a clarifier unit.

16. The method of claim 15, wherein separating the entrained particles comprises separating a dregs stream from a liquid recovery stream, wherein the dregs stream comprises the entrained particles and a vinylamine-containing polymer.

17. The method of claim 1, wherein providing the water stream comprises providing a tailings stream from a mining operation.

18. The method of claim 1, wherein the clarifying composition comprises the vinylamine-containing polymer or precursor(s) thereof in an amount of at least about 40 weight %, based on a total weight of the clarifying composition.

19. The method of claim 18, wherein the clarifying composition is added in an amount of from about 2 to about 10 ppm, based on a total amount of the water stream.

20. A papermaking process comprising:
cooking a fibrous material in white liquor to produce kraft pulp;
separating the kraft pulp from black liquor after cooking;
processing the black liquor to produce a combusted smelt product;
dissolving the combusted smelt product in water to produce green liquor, wherein the green liquor comprises water and entrained particles, and wherein the green liquor has a pH of at least about 8 and a temperature of at least about 50° C.;
combining the green liquor and a clarifying composition comprising vinylamine-containing polymer or precursor(s) thereof; and
separating the entrained particles from the water after combining the green liquor and the clarifying composition.
